(19) United States
(12) Patent Application Publication
(10) Pub. No.: US 2004/0015518 A1
(43) Pub. Date: Jan. 22, 2004

(54) System and method for monitoring material on shop floors

(76) Inventors: Alex Lee, Tu-Chen (TW); Sheng Chi Luo, Tu-chen (TW); WenZhen Ma, Shenzhen (CN); XiangHua Ji, Shenzhen (CN); QiongShuai Chen, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/617,055

(22) Filed: Jul. 9, 2003

(30) Foreign Application Priority Data
Jul. 18, 2002 (TW) 91115971

(51) Int. Cl. G06F 7/00

(52) U.S. Cl. 707/104.1

(57) ABSTRACT

A system and method for monitoring material on shop floors is provided. The system displays regional production by country, factory, workshop and line using a two-dimensional graphic or a three-dimensional graphic, and specifies production information for each country, factory, workshop or line in a table. The monitoring system includes at least one subsidiary company database for storing material data for the associated subsidiary company; a central database for storing global material data; a material monitoring system server and an application program on the material monitoring system server, which selects, integrates, classifies, and controls display of data.

### BACKGROUND OF THE INVENTION

1. Field of the Invention

The present invention relates to a system and method for monitoring material on shop floors, and particularly to a system and method for displaying regional production by country, factory, workshop and line using a two-dimensional graphic or a three-dimensional graphic, and specifying production information for each country, factory, workshop or line in a table.

2. Background of the Invention

Common problems in manufacturing include managing production and inventories to prevent overstocking, reducing market risks in materials stocking to ensure adequate material supplies; and adjusting manufacturers must have production to meet market demand. To solve these problems, manufacturers must have timely, dynamic production information to allow them to adjust production flow to meet the market demand as reported by the sales department.

Information technologies are now available to help solve these problems. These technologies include network technology, communications technology, and database technology. Used together, they can help a manufacturer to know the quantitative conditions of materials on shop floors.

U.S. Pat. No. 6,233,410 titled “Consumable Material Management System and Method” discloses a system and method for managing consumable materials using network and database technology. This consumable material management system and method has some shortcomings. For instance, it cannot clearly describe the condition of the consumable material, and it only reads and updates material information.

Therefore, it is desirable to provide a system and method for monitoring material on shop floors which displays regional production by country, factory, workshop and line using a two-dimensional graphic or a three-dimensional graphic, and which specifies production information for each country, factory, workshop or line in a table.

### SUMMARY OF THE INVENTION

An object of the present invention is to provide a system for monitoring material on shop floors, by which managers can view the integrated information of shop floor material of subsidiary companies located around the world.

A second object of the present invention is to provide a method for monitoring material on shop floors, by which managers can view the integrated information of shop floor material of subsidiary companies located around the world.

A third object of the present invention is to provide a system for monitoring material on shop floors, which displays regional production by country, factory, workshop and line using a two-dimensional graphic or a three-dimensional graphic, and which provides global production information for each country, factory, workshop or line in a table.

A fourth object of the present invention is to provide a method for monitoring material on shop floors, which displays regional production by country, factory, workshop and line using a two-dimensional graphic or a three-dimensional graphic, and which provides global production information for each country, factory, workshop or line in a table.

The present invention provides a system for monitoring material on shop floors, which comprises a central database, a central database server, at least one subsidiary company database, at least one subsidiary company database server, a material monitoring system server with an application program, a plurality of client computers and a network. Wherein the central database is used to gather material information and store two-dimensional graphics, three-dimensional graphics and data tables; the at least a subsidiary company database is used to store material data of a respective subsidiary company and connects with the central database via the respective subsidiary company database server, the network, and the central database server; the material monitoring system server is used to invoke material information stored in the central database according to the plurality of client computers; the application program is used to display production information with a two-dimensional graphic or a three-dimensional graphic and which is used to display information on materials in a table.

The present invention provides a method for monitoring material on shop floors. The method comprises the following steps: (a) selecting a position from a graphic; (b) refreshing and displaying the graphics according to the selection; (c) connecting with a central database to read and transmit relevant data to a data integrating module; (d) integrating and classifying the transmitted data; and (e) generating a table specific to the graphic.

### BRIEF DESCRIPTION OF THE DRAWINGS

FIG. 1 is a schematic diagram of a system for monitoring material on shop floors in accordance with a preferred embodiment of the present invention;

FIG. 2 is an example of a client interface graphic for the system of FIG. 1;

FIG. 3 is a block diagram showing the components of the application program of a system for monitoring material on shop floors;

FIG. 4 is a block diagram showing the components of the graphic displaying module of a system for monitoring material on shop floors;

FIG. 5 is a block diagram showing the components of the data integrating module of a system for monitoring material on shop floors;

FIG. 6 is a main flowchart for a method of monitoring material on shop floors using the system of FIG. 1;

FIG. 7 is a flowchart of a second embodiment of a method of monitoring material on shop floors.

### DETAILED DESCRIPTION OF THE INVENTION

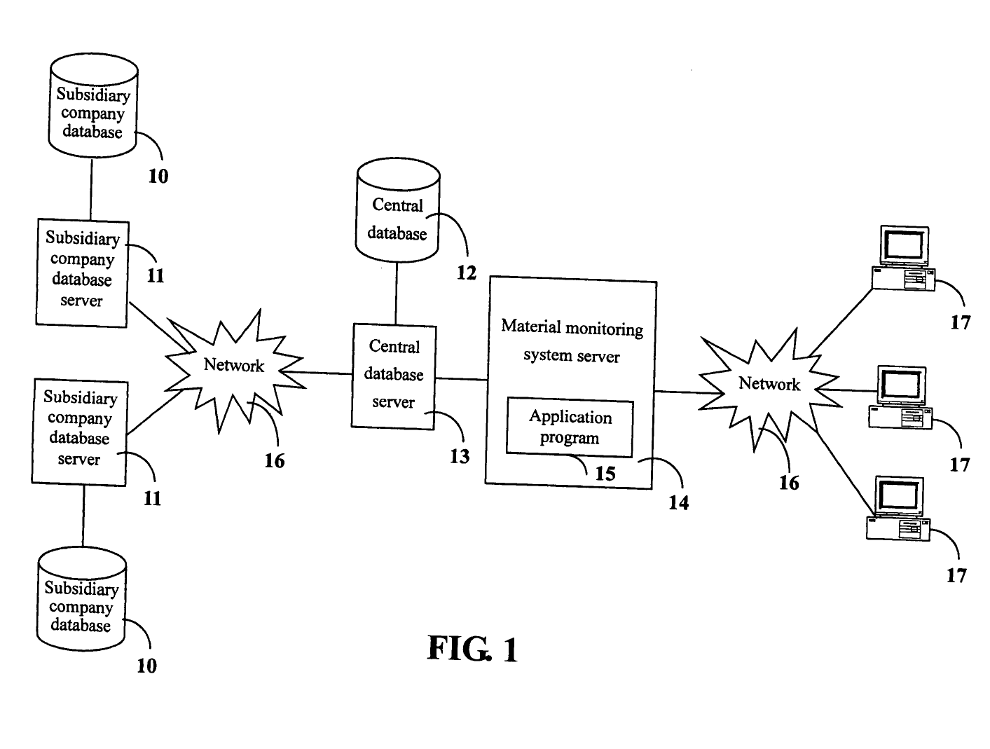

As shown in FIG. 1, a structure of a system for monitoring material on shop floors worldwide comprises at least one subsidiary company database 10, at least one subsidiary company database server 11, a central database 12, a central database server 13, a material monitoring system server 14, a network 16, and a plurality of client computers 17. The plurality of client computers 17 connects with the material monitoring system server 14 via the network 16 to allow searching for material information on the shop floors. This network 16 between the plurality of client computers 17 and the material monitoring system server 14 has a B/S (browser-server) structure.

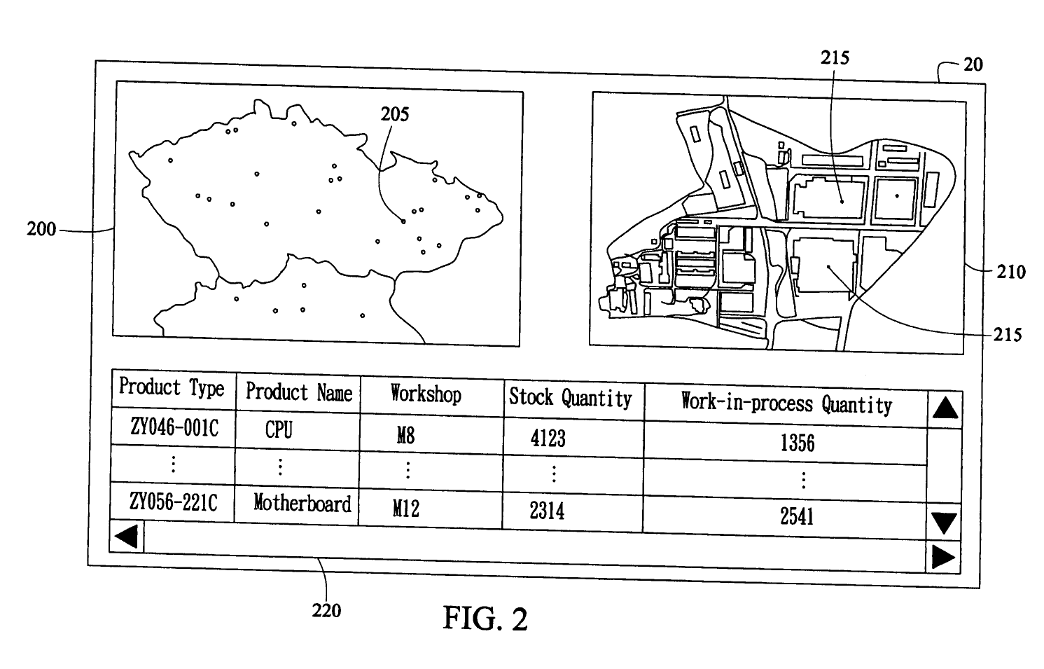

Referring also to FIG. 1, the material monitoring system server 14 runs an application program 15. The application program 15 supports a client interface graphic 20 (as shown in FIG. 2) including a large scale graphic 200 (as shown in FIG. 2), a magnified graphic 210 (as shown in FIG. 2), and a table 220 (as shown in FIG. 2) specifying global material information.

Referring also to FIG. 1, the central database 12 connects with at least one subsidiary company database 10 via the central database server 13, the network 16, and the subsidiary company database server 11. The subsidiary company database 10 stores material data for the subsidiary, updates material data, and transmits the updated data to the central database 12. The central database 12 collects the material data of all the subsidiary companies and transmits the updated data to the material monitoring system server 14. The application program 15 integrates the updated data and stores the integrated data in the central database 12.

As shown in FIG. 2, the client interface graphic 20 comprises the large scale graphic 200, the magnified graphic 210, and the table 220. A plurality of position selection dots 205, and a plurality of magnification selection dots 215 are shown respectively in the large scale graphic 200 and the magnified graphic 210. The large scale graphic 200 displays regional production worldwide, by country, by factory, or by workshop. The magnified graphic 210 is a magnification of the regional production at a given position selection dot 205 in the current large scale graphic 200, and displays production by country, factory, workshop, or line. The magnified graphic is, therefore, at all times the next step down the large scale graphic 200. The table 220 specifies the production information for each selected country, factory, workshop, or line indicated by the selected magnification selection dot 215 in the magnified graphic 210. The plurality of position selection dots 205 in the large scale graphic 200 each corresponding to a different production area, either to a country, a factory, a workshop, or a line. The plurality of magnification selection dots 215 in the magnified graphic 210 each corresponding to a different production area, either to a factory, a workshop, or a line. Initially, the large scale graphic 200 is a global graphic (not shown in the Figures) and the plurality of position selection dots 205 in the global graphic correspond to different countries. When a user clicks on one of the plurality of position selection dots 205 in the global graphic, the magnified graphic 210 displays the graphic of the selected country, along with the plurality of magnification selection dots 215 in that country's graphic, each corresponding to a different factory. At the same time, the table 220 specifies the production information for the selected country. When the user clicks on one of the magnification selection dots 215 in the country graphic, the large scale graphic 200 changes to display the country graphic previously displayed in the magnified graphic 210, and the plurality of position selection dots 205 in the country graphic now correspond to different factories in the country, while the magnified graphic 210 now displays the graphic of the selected factory, along with the plurality of magnification selection dots 215 in that factory's graphic, each corresponding to a different workshop (all as shown representatively in FIG. 2), At the same time, the table 220 specifies the production information for the selected factory (as shown representatively in FIG. 2). When the user now clicks on one of the magnification selection dots 215 in the factory graphic, the large scale graphic 200 changes to display the factory graphic previously displayed in the magnified graphic 210 and the plurality of position selection dots 205 in the factory graphic now correspond to different workshops in the factory, while the magnified graphic 210 now displays the graphic of the selected workshop, along with the plurality of magnification selection dots 215 in that workshop's graphic, each corresponding to a different line. At the same time, the table 220 specifies the production information for the selected workshop (not shown in the Figures). When the user then clicks on one of the magnification selection dots 215 in the workshop graphic, the large scale graphic 200 changes to display the workshop graphic previously displayed in the magnified graphic 210, and the plurality of position selection dots 205 in the workshop graphic now correspond to different lines in the workshop while the magnified graphic 210 now displays the graphic of the selected line. At the same time, the table 220 specifies the production information for the selected line (not shown in the Figures).

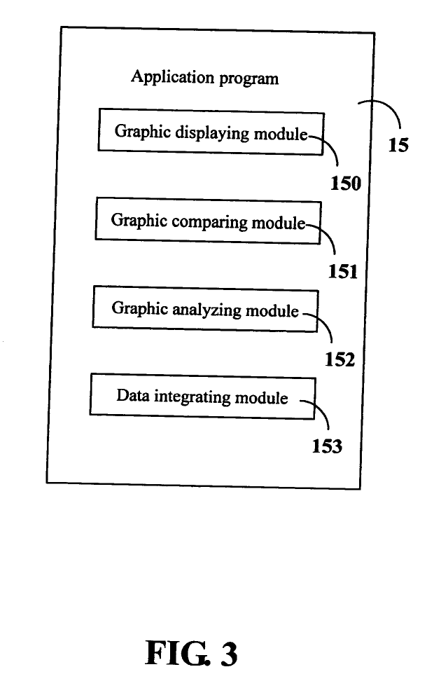

FIG. 3 shows a block diagram showing the components of the application program. The application program 15 comprises a graphic displaying module 150, a graphic comparing module 151, a graphic analyzing module 152 and a data integrating module 153. The graphic displaying module 150 accesses the central database 12 to display and refresh the large scale graphic 200 and the magnified graphic 210 depending on a position selection dot 205 selected on the large scale graphic 200, or a magnification selection dot 215 selected on the magnified graphic 210. The graphic comparing module 151 compares the relation between the large scale graphic 200 and the magnified graphic 210 for the user to grasp the material information on the present shop floors; the magnified graphic 210 is a magnified graphic of a part of the position graphic 200. The graphic analyzing module 152 evokes the production information relevant to the magnified graphic 210 stored in the central database 12 and analyzes, selects, and transmits the information to the data integrating module 153. The data integrating module 153 integrates and classifies the information received from the graphic analyzing module 152 and displays the integrated data in the table.

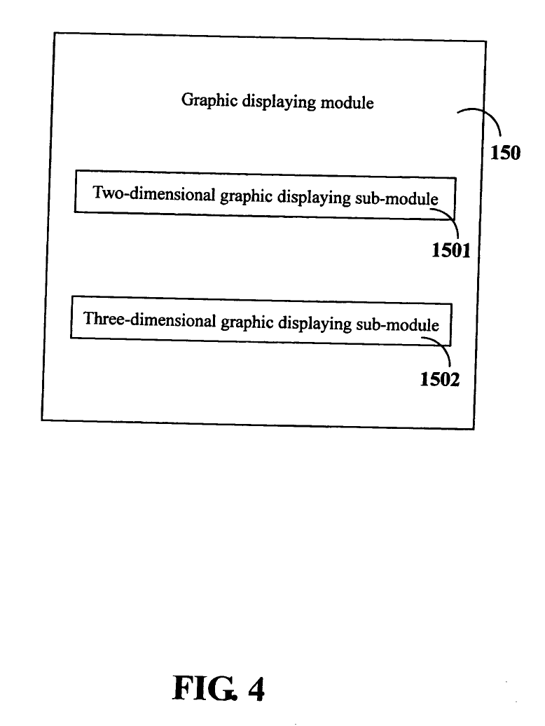

FIG. 4 shows a block diagram showing the components of the graphic displaying module 150. The graphic displaying module 150 comprises a two-dimensional graphic displaying sub-module 1501 and a three-dimensional graphic displaying sub-module 1502. The two-dimensional graphic displaying sub-module 1501 supports display of a two-dimensional graphic determined by the position selection dot 205 selected on the large scale graphic 200 and the magnification selection dot 215 selected on the magnified graphic 210 by a user. The three-dimensional graphic displaying sub-module 1502 supports display of a three-dimensional graphic determined by the position selection dot 205 selected on the large scale graphic 200 or the magnification selection dot 215 selected on the magnified graphic 210 by the user.

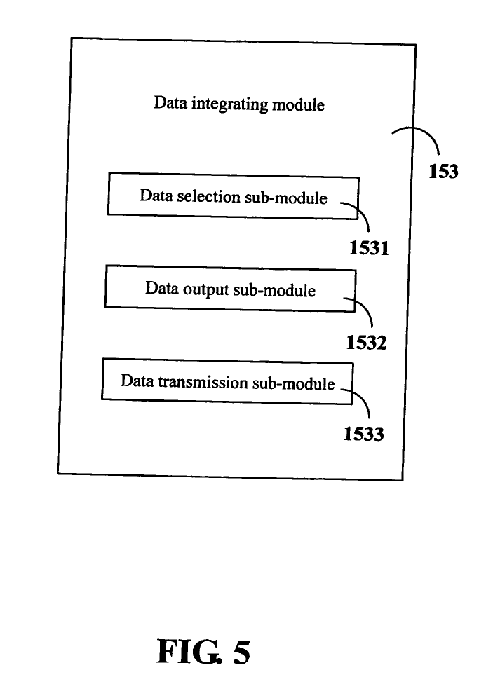

FIG. 5 shows a block diagram showing the components of the data integrating module 153. The data integrating module 153 comprises a data selection sub-module 1531, a data output sub-module 1532 and a data transmission sub-module 1533. The data selection sub-module 1531 selects and integrates data stored in the central database 12 depending on the graphic to be displayed. The data output sub-module 1532 gathers the data integrated by the data selection sub-module 1531, generates table data needed, displays the table data in the table with the graphics, and feeds information back to the central database 12. The data transmission sub-module 1533 assists the data selection sub-module 1531 in evoking the graphic data from the central database 12, transmits the data selected and integrated by the data selection sub-module 1531 to the data output sub-module 1532 for displaying, and transmits the integrated data to the central database 12.

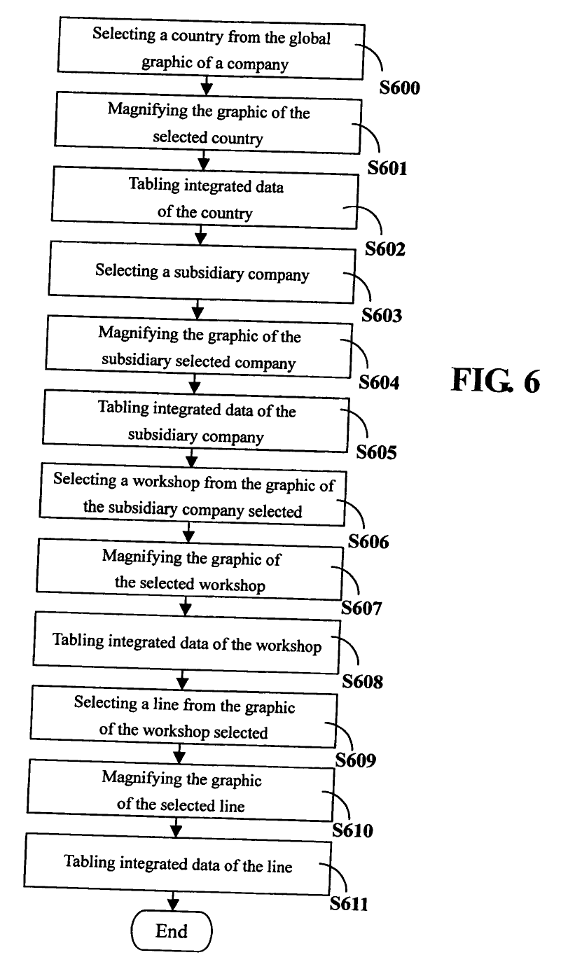

As shown in FIG. 6, a main flowchart of a method for monitoring material on shop floors includes a number of steps. In step S600, a user clicks on a country having a subsidiary company shown on the global graphic of a company. In step S601, the graphic displaying module 150 displays the graphic of the selected country. In step S602, the data integrating module 153 integrates information relevant to each of the subsidiary companies of the selected country displayed in the graphic and displays the integrated data in the table 220. In step S603, the user clicks on any of the subsidiary companies shown on the graphic of the selected country. In step S604, the graphic displaying module 150 displays the graphic of the selected country as the large scale graphic 200 and at the same time displays the graphic of the subsidiary company selected as the magnified graphic 210. In step S605, the data integrating module 153 integrates information relevant to the subsidiary company selected and displays the integrated data in the table 220. In step S606, the user clicks on any of the workshops shown on the graphic of the subsidiary company selected. In step S607, the graphic displaying module 150 displays the graphic of the subsidiary company selected as the large scale graphic 200 and at the same time displays the graphic of the workshop selected as the magnified graphic 210. In step S608, the data integrating module 153 integrates information relevant to the workshop selected and displays the integrated data in the table 220. In step S609, the user clicks on any of the lines shown on the graphic of the workshop selected. In step S610, the graphic displaying module 150 displays the graphic of the workshop selected as the large scale graphic 200 and at the same time displays the graphic of the selected line as the magnified graphic 210. In step S611, the data integrating module 153 integrates information relevant to the selected line and displays the integrated data in the table 220.

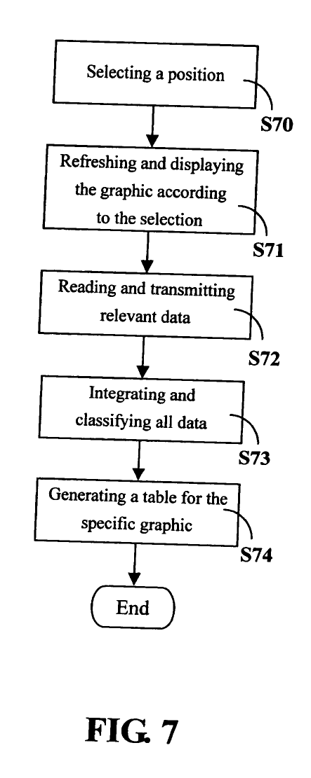

FIG. 7 shows a flowchart of a second embodiment of a method for monitoring material on shop floors. In step S70, a user selects a position from the global graphic of a company, or the graphic of a country, or the graphic of a subsidiary company, or the graphic of a workshop. In step S71, the graphic displaying module 150 refreshes the graphic and displays the graphic determined by the user's selection. In step S72, the graphic analyzing module 152 accesses the central database 12 and evokes and transmits relevant data to the data integrating module 153. In step S73, the data integrating module 153 integrates and classifies all the received data. In step S74, the data integrating module 153 generates a table for the specific graphic.

The preferred embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims which follow and their equivalents.

What is claimed is:

1. A system for monitoring material on shop floors, comprising:
a central database;
a central database server;
at least one subsidiary company database;
at least one subsidiary company database server;
a material monitoring system server;
a plurality of client computers; and
a network interconnecting the central database, the central database server, the subsidiary company database, the subsidiary company database server, the material monitoring system server and the client computers, wherein:
the central database is used to gather material information and store two-dimensional graphics three-dimensional graphics and data tables;
the central database server is used to manage the central database;
the at least a subsidiary company database is used to store material data of a respective subsidiary company and connects with the central database via the respective subsidiary company database server, the network, and the central database server;
the at least a subsidiary company database server is used to manage the respective subsidiary company database;
the plurality of client computers connects with the material monitoring system server via the network so that users can search for production information from the client computers;
the material monitoring system server is used to invoke material information stored in the central database according to the plurality of client computers, the material monitoring system server further comprising:
an application program, which is used to display production information with a two-dimensional graphic or a three-dimensional graphic and which is used to display information on materials in a table.

2. The system as described in claim 1, wherein the two-dimensional graphics or three-dimensional graphics are stored in the central database and comprise a worldwide graphic of a company, graphics of each individual country having a subsidiary company, graphics of each subsidiary company in each country, graphics of each workshop in each subsidiary company, and graphics of each line in each workshop.

3. The system as described in claim 1, wherein the two-dimensional graphics or three-dimensional graphics stored in the central database comprise a plurality of position selection dots.

4. The system as described in claim 1, wherein two-dimensional graphics or three-dimensional graphics stored in the central database comprise a plurality of magnification selection dots.

5. The system as described in claim 1, wherein the application program comprises a graphic displaying module, which is used to display and refresh graphics according to selections made by users.

6. The system as described in claim 5, wherein the graphic displaying module comprises a two-dimensional graphic displaying sub-module, which is used to display a two-dimensional graphic according to selections made by users.

7. The system as described in claim 5, wherein the graphic displaying module comprises a three-dimensional graphic displaying sub-module, which is used to display a three-dimensional graphic according to selections made by users.

8. The system as described in claim 1, wherein the application program comprises a graphic comparing module, which is used to compare the large scale graphic and the magnified graphic.

9. The system as described in claim 1, wherein the application program comprises a graphic analyzing module, which is used to select and analyze the data stored in the central database according to selections made by users.

10. The system as described in claim 1, wherein the application program comprises a data integrating module, which is used to integrate and classify data received and to display integrated data in a table.

11. The system as described in claim 10, wherein the data integrating module comprises a data selection sub-module, which is used to select data stored in the central database according to the graphic displayed.

12. The system as described in claim 10, wherein the data integrating module comprises a data output sub-module, which is used to gather the integrated data, generate tables needed, display the tables with the graphics, and feed back to the central database.

13. The system as described in claim 10, wherein the data integrating module comprises a data transmission sub-module, which is used to transmit the data selected by the data selection sub-module to the data output sub-module for integrating, and to transmit the integrated data to the central database.

14. A method for monitoring material on shop floors comprising the following steps:
(a) selecting a position from a graphic;
(b) refreshing and displaying the graphics according to the selection;
(c) connecting with a central database to read and transmit relevant data to a data integrating module;
(d) integrating and classifying the transmitted data; and
(e) generating a table specific to the graphic.

15. The method as described in claim 14, wherein the graphic can be a global graphic of a company, a graphic of a country, a graphic of a subsidiary company, or a graphic of a workshop.

16. A method of monitoring material on shop floors of workshops of subsidiary companies of an enterprise, comprising the steps of:
selecting a country from a global graphic of the enterprise;
magnifying a graphic of the selected country;
tabling integrated data of the selected country;
selecting one of said subsidiary companies from the graphic of the selected country;
magnifying a graphic of the selected one of said subsidiary companies;
tabling integrated data of the selected one of said subsidiary companies;
selecting one of said workshops form the graphic of the selected one of said subsidiary companies;
magnifying a graphic of the selected one of said workshops;
tabling integrated data of said selected one of said workshops;
selecting a product line from the graphic of the selected one of said workshops;
magnifying a graphic of said selected product line; and
tabling integrated data of the product line.
